(19) United States
(12) Patent Application Publication
(10) Pub. No.: US 2009/0236448 A1
(43) Pub. Date: Sep. 24, 2009

(54) Fuel injector lower filter

(76) Inventors: Kimberly Burkhard, Churchvile, NY (US); Allan R. Wells, Rochester, NY (US); Dominic N. Dalo, Rochester, NY (US); David A. Webb, Rochester, NY (US); Otto Muller-Girard, JR., Rochester, NY (US); Vicki A. Flynn, Penfield, NY (US); Peter R. Wendt, Fairport, NY (US)

Correspondence Address: Paul L. Marshall Esq.;Delphi Technologies, Inc., Mail Code 480410202, P.O. Box 5052, Troy, MI, 48007, US

(21) Appl. No.: 12/077,400

(22) Filed: Mar. 18, 2008

(51) Int. Cl. B05B 1/30; B05B 1/00; F02M 61/10

(52) U.S. Cl. 239/575; 239/596; 239/533.11

(57) ABSTRACT

A lower filter for a fuel injector includes a disk having an annular shape and including a plurality of filter holes. The disk is positioned upstream of a valve guide of an internal valve assembly without contacting the valve guide. The disk prevents internally generated contaminants contained in fuel flowing through the filter holes from reaching a valve guide area and a sealing area of the internal valve assembly. By installing the lower filter upstream of the valve guide and without contact to the valve guide, interference with the guidance and reciprocal movement of the valve is avoided. Application of the lower filter in fuel injectors may reduce the occurrence of injector failures by reducing the number of stuck open conditions in injectors and by reducing the number of hydro lock engine incidents without interference with the valve guide.

### TECHNICAL FIELD

The present invention relates to fuel injection systems of internal combustion engines; more particularly, to fuel injectors; and most particularly, to an internal lower filter of a fuel injector.

### BACKGROUND OF THE INVENTION

Fuel injected internal combustion engines are well known. Fuel injection is a way of metering fuel into an internal combustion engine. Fuel injection arrangements may be divided generally into multi-port fuel injection (MPFI), wherein fuel is injected into a runner of an intake manifold ahead of a cylinder intake valve, and direct injection (DI), wherein fuel is injected directly into the combustion chamber of an engine cylinder, typically during or at the end of the compression stroke of the piston.

A typical fuel injector includes an internal valve assembly that may include a reciprocably actuated ball that seals against a beveled circular seat in a circular sealing line. A guide that assists in positioning the ball relative to the seat may further be included in the internal valve assembly.

It is most desirable, in a modern internal combustion engine, to precisely control the flow of fuel to the combustion chamber in order to meet performance requirements as well as emission regulations. Therefore, it is desirable to ensure that the ball completely seals against the seat when the valve assembly is in a closed position to avoid fuel passage when not needed. It is known to position an upper filter proximate to a fuel inlet of the injector. While the upper filter may capture contaminants generated upstream of the fuel injector, it cannot capture contaminants that may be generated during the assembly and/or operation of the fuel injector. It is important to prevent contamination of the area between the ball and the seat. Contamination between the ball and seat may be caused by internally generated particles which may lead to a malfunction of the injector. Malfunction of the injector due to contamination could result in a stuck open condition of one or multiple injectors. With the injector stuck open, uncontrolled amounts of fuel may enter the engine's combustion chamber, which may cause a hydraulic lock of the engine. Contaminants may be generated within the fuel injector, for example during injector assembly operations, due to insufficient cleaning of the fuel injector parts prior to assembly, or during operation of the fuel injector, for example, due to friction and wear of the contacting surfaces. It is currently not possible to completely eliminate such internal contamination of a fuel injector.

A stuck open condition can lead to a severe failure mode for the injector and, therefore, injector manufacturing companies try, from both a design and a process stand point, to prevent such a failure mode by eliminating contamination as much as possible. In order to further reduce contamination of the fuel flowing through the injector with particles of internal origin, filters have been disposed internally of the fuel injector between the fuel inlet and the fuel outlet in the prior art. While such internal filters may prevent internally generated contaminants from reaching the internal valve assembly and from getting stuck between the ball and the seat, such prior art internal filters are typically supported by the valve guide, which may interfere with the accurate positioning of the ball relative to the seat.

What is needed in the art is an internal filter for a fuel injector that is positioned in close proximity to the fuel outlet and that does not interfere with the accurate positioning of the ball relative to the seat.

It is a principal object of the present invention to provide a self-supporting internal lower filter for a fuel injector that is assembled in the seat above a ball guide of an internal valve assembly of the fuel injector.

### SUMMARY OF THE INVENTION

Briefly described, a lower fuel filter is assembled internally of a fuel injector downstream of a fuel inlet and upstream of a valve guide. The lower filter may be, for example, a stainless steel filter with photo chemically etched holes. By positioning the lower filter upstream of the guide, contrary to the known prior art, contact of the filter with the guide is eliminated. Thus, interference with the positioning function of the guide is avoided while, at the same time, particulates that may be generated internally in the injector are captured before reaching the valve guide area and the sealing area between the seat and the ball.

In one aspect of the invention, the lower filter is a self-supporting annular disk that may be welded, for example by laser welding or by resistance welding, to a shoulder integral with the seat. The shoulder is integrated into the seat such that the annular disk is positioned in close proximity to the guide without contacting the guide.

In another aspect of the invention, the lower filter is attached to a retaining ring that is then assembled in the seat either by a press fit into the inner diameter of the seat or by a snap fit into a groove integrated into the inner diameter of the seat. It may further be possible to capture the retaining ring with the attached filter between the body of the fuel injector and the seat during injector assembly. The retaining ring, with the filter attached, may be assembled in the seat upstream of the guide to avoid interference with the guidance of the ball.

In still another aspect of the invention, the filter is attached to an annular support ring containing fuel flow holes. The annular support ring and filter assembly is then assembled into the inner diameter of the seat with a close tolerance fit to the valve shaft outer diameter to prevent built in contaminants from flowing down to the ball and seat interface. The annular support ring and filter subassembly are assembled in the seat either by a press fit into the inner diameter of the seat or by a snap fit into a groove integrated into the inner diameter of the seat. It may further be possible to capture the annular support ring and filter subassembly between the body of the fuel injector and the seat during injector assembly.

The lower filter in accordance with the invention may be used preferably in multi-port fuel injection (MPFI) injectors, but may be applicable in direct injection (DI) fuel injectors as well. Integration of a lower internal filter into MPFI injectors is desirable, since due to the lower fuel pressure compared to DI, there is a higher possibility for contaminants getting trapped between the ball seat and the ball. Thus, without interfering with the guidance of the valve, the application of the lower filter above a valve guide in accordance with the invention in fuel injectors may reduce the occurrence of injector failure.

### BRIEF DESCRIPTION OF THE DRAWINGS

The present invention will now be described, by way of example, with reference to the accompanying drawings, in which:

FIG. 1a is an isometric view of a lower filter, in accordance with the invention;

FIG. 1b is an enlarged partial view of a filter area enclosed by circle 1b in FIG. 1a, in accordance with the invention;

FIG. 1c is a partial cross-sectional view along line 1c-1c in FIG. 1a, in accordance with the invention;

FIG. 1d is a partial cross-sectional view of a dimpled lower filter, in accordance with the invention;

FIG. 2 is a cross-sectional view of a cartridge assembly of a fuel injector, in accordance with the invention;

FIG. 3 is a cross-sectional view of a detail of the fuel injector shown in FIG. 2, in accordance with the invention;

FIG. 4 is a cross-sectional view of a second internal valve assembly, in accordance with the invention;

FIG. 5 is a cross-sectional view of the second internal valve assembly, in accordance with another aspect of the invention;

FIG. 6 is a cross-sectional view of the second internal valve assembly, in accordance with still another aspect of the invention;

FIG. 7 is a cross-sectional view of a third internal valve assembly, in accordance with the invention;

FIG. 8 is a cross-sectional view of the third internal valve assembly, in accordance with another aspect of the invention;

FIG. 9a is an isometric top view of an annular support ring, in accordance with the invention;

FIG. 9b is an isometric bottom view of the annular support ring, in accordance with the invention; and

FIG. 9c is an isometric cross-sectional view of the annular support ring, in accordance with the invention.

Corresponding reference characters indicate corresponding parts throughout the several views. The exemplification set out herein illustrates preferred embodiments of the invention, in one form, and such exemplification is not to be construed as limiting the scope of the invention in any manner.

### DESCRIPTION OF THE PREFERRED EMBODIMENTS

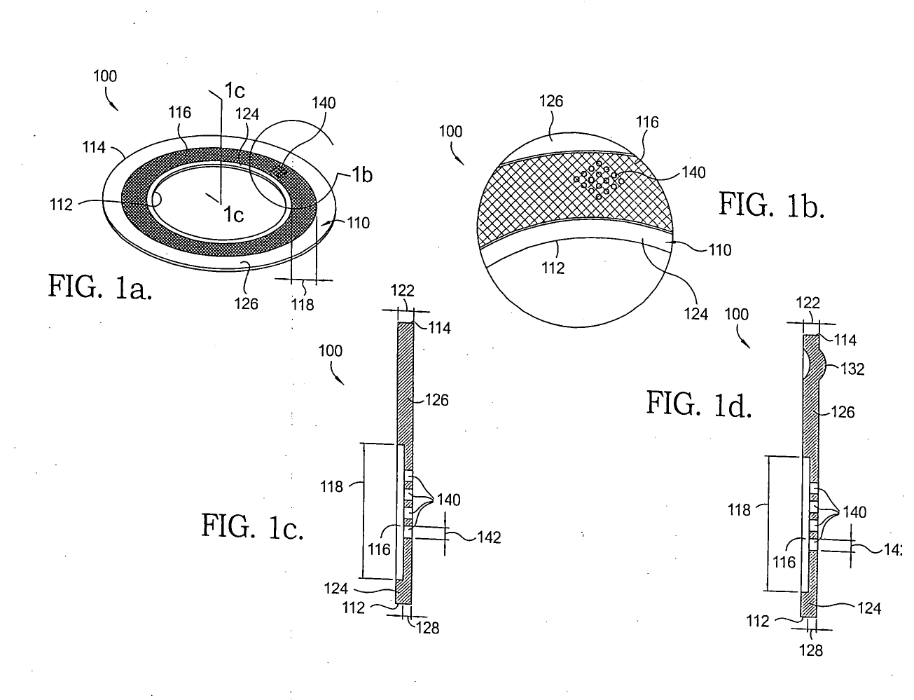

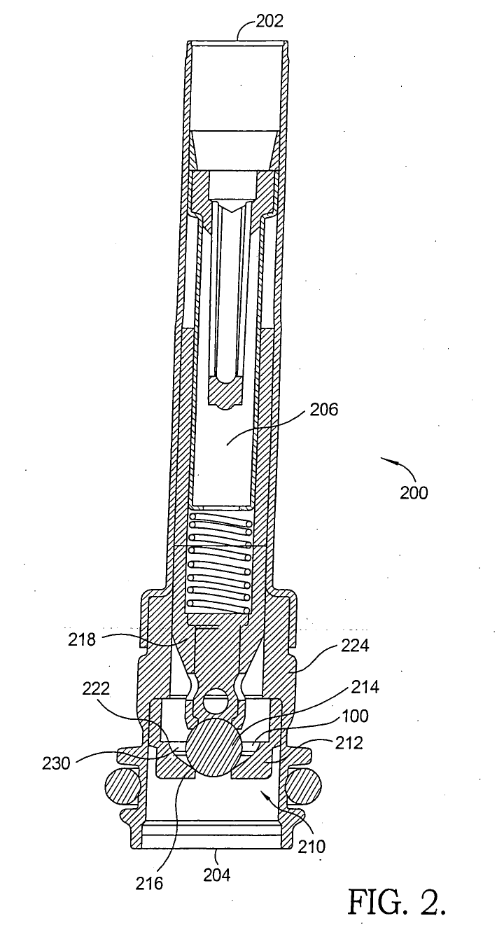

Referring to FIGS. 1a through 1d, a lower filter 100 is a disk 110 that has an annular shape including an inner diameter 112 and an outer diameter 114. Lower filter 100 includes a circular filter hole area 116 extending for a width 118 between inner diameter 112 and outer diameter 114. Disk 110 has a thickness 122 that is preferably the same in an area 124 adjacent to inner diameter 112 and in an area 126 adjacent to outer diameter 114. Circular filter hole area 116 may have a reduced thickness 128 and is positioned between the areas 124 and 126 as shown in FIG. 1c. Thickness 122 and reduced thickness 128 of disk 110 are preferably chosen such that stability of disk 110 is ensured and such that disk 110 is self-supporting. While filter hole area 116 is shown in FIGS. 1a through 1d to have a reduced thickness 128, it may be possible that filter hole area 116 has the same thickness 122 as adjacent areas 124 and 126. Area 126 adjacent to outer diameter 114 may be designed to have a larger width than area 124 adjacent to inner diameter 112. Area 126 may be primarily used to assemble lower filter 100 in a fuel injector as shown in FIGS. 2 through 8. Dimples 132 may be formed in area 126 as shown in FIG. 1d enabling resistance weld retention of lower filter 100. Dimples 132 may be formed, for example, in three places preferably 120 degrees spaced apart. Disk 110 may be, for example, formed from stainless steel.

Filter hole area 116 shown in detail in FIG. 1b includes a plurality of filter holes 140. Filter holes 140 may be, for example, chemically etched holes. It may further be possible to form filter holes 140 in disk 110 by laser drilling, stamping, or other machining operations. Filter holes 140 may be formed in a strip of material before disk 110 is, for example, stamped off the strip.

To maximize fuel flow through a fuel injector and the filter efficiency of lower filter 100, as many filter holes 140 as desired without reducing the stability of disk 110 may be formed in reduced thickness area 128. Filter holes 140 have a diameter 142 that may be the same for each of the filter holes 140 or that may not be the same for each of the filter holes 140. The diameter 142 of filter holes 140 is preferably smaller than the largest possible distance between a ball, such as ball 214, 314, or 414, and a seat, such as seat 212, 312, or 412, when a valve assembly, such as valve assembly 210, 310, or 410 (shown in FIGS. 2, 4, and 7, respectively) is in an open position. Filter holes 140 may be grouped and/or arranged in a pattern, for example in a rhombus as shown in FIG. 1b. Other patterns are possible and the pattern of filter holes 140 may depend on the forming process of filter holes 140 in disk 110.

Referring to FIG. 2, a cartridge assembly of a fuel injector 200 is illustrated. Fuel injector 200 extends axially from a fuel inlet end 202 to a fuel outlet end 204, encloses a fuel passage 206, and includes a first internal valve assembly 210 positioned upstream of and proximate to fuel outlet end 204 within fuel injector 200. Fuel injector 200 may be a fuel injector for multi-port fuel injection as shown in FIG. 2. Fuel injector 200 may further be a fuel injector for direct injection.

A body 224 of fuel injector 200 houses internal valve assembly 210. Internal valve assembly 210 includes a valve seat, such as beveled circular seat 212, a reciprocably actuated valve, such as ball 214, that seals against seat 212, for example, in a circular sealing area 216, and a shaft 218 extending axially from ball 214. Shaft 218 may be hollow. Internal valve assembly 210 regulates the fuel flow through fuel outlet end 204. A guide 230 that directs ball 214 is positioned in close proximity to and upstream of sealing area 216 within seat 212. Lower filter 100, as shown in detail in FIGS. 1a through 1d, is positioned upstream of guide 230 without contacting guide 230 to avoid interference with the positioning function of guide 230 while particulates that may be generated internally in the injector and that may be harmful to the injector operation are captured before reaching a valve guide area 232 between guide 230 and ball 214 and sealing area 216 between the seat 212 and the ball 214. Lower filter 100 may be assembled in fuel injector 200 in close proximity of guide 230 and with a close tolerance fit to the outer circumference of ball 214 as shown in FIG. 2.

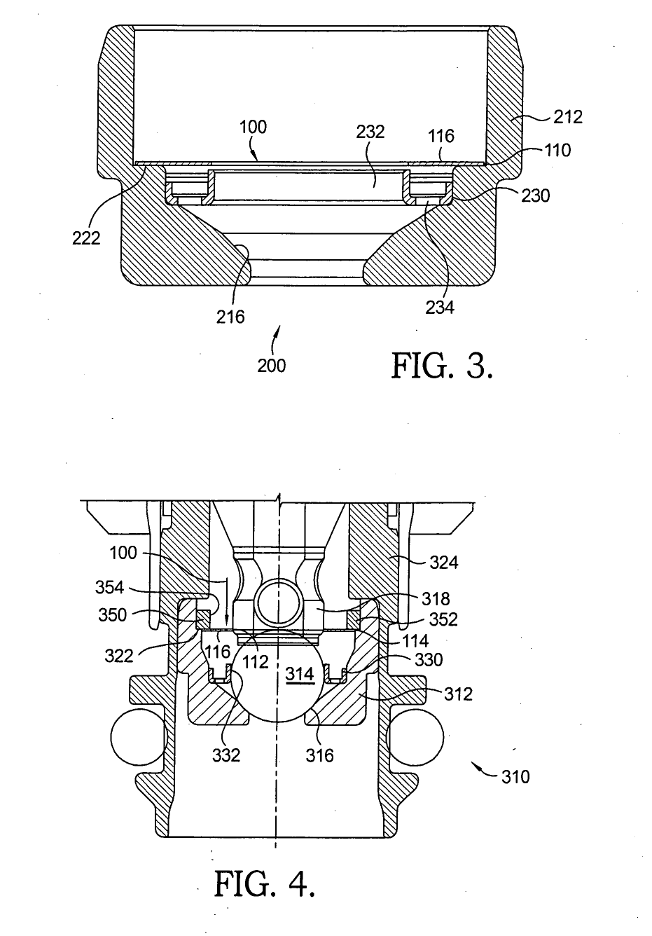

Referring to FIG. 3, guide 230 and lower filter 100 are shown assembled in seat 212 of fuel injector 200. As can be seen, seat 212 includes a shoulder 222 that supports lower filter 100. Lower filter 100 is assembled into seat 212 until disk 110 makes contact with shoulder 222. Outer diameter 114 of disk 110 of lower filter 100 fits closely into an inner circumferential contour of seat 212. Inner diameter 112 of disk 110 is designed to closely fit around ball 214 as shown in FIG. 1, precluding particles or internal contaminants from entering valve guide area 232 and sealing area 216. Shoulder 222 is adapted to receive area 126 of disk 110. When lower filter 100 is installed in seat 212, filter hole area 116 is preferably positioned axially above a fuel passage 234 of guide 230. Shoulder 222 is designed such that lower filter 100 is positioned upstream of guide 230, in close proximity to guide 230, and such that contact between lower filter 100 and guide 230 is avoided. Preferably, lower filter 100 is positioned at least about 100 μm above guide 230. However, this position may be varied.

Fuel flowing from fuel inlet end 202 to fuel outlet end 204 through fuel injector 200 (all shown in FIG. 2) passes through lower filter 100 before passing through guide 230 and entering sealing area 216. Any particles or contaminants in the fuel flow that are generated downstream of fuel inlet end 202 within fuel injector 200, for example during the assembly process or during operation, that have a size that may be harmful for injector operation, and that are larger than diameter 142 of filter holes 140 are captured by lower filter 140 and, therefore, precluded from entering valve guide area 232 and sealing area 216.

Lower filter 100 may be retained in seat 212, for example, by welding, such as spot welding, area 126 of disk 110 to shoulder 222. This could be done, for example by laser welding or resistance welding. In the case of laser welding, disk 110 could be spot welded to shoulder 222, for example, in three spots positioned in area 126 and spaced apart by 120 degrees. In the case of resistance welding, disk 110 need to include dimples 132 as shown in FIG. 1d.

While lower filter 100 is shown in FIG. 3 as being assembled in seat 212 with filter hole area 116 facing guide 230, it may be possible to assemble lower filter 100 with filter hole area 116 facing away from guide 230 and facing fuel inlet end 202.

Referring to FIGS. 4 through 6, a second internal valve assembly 310 includes a seat 312, a reciprocably actuated ball 314, that seals against seat 312, for example, in a circular sealing area 316, and a shaft 318 extending axially from ball 314. A guide 330 that directs ball 314 is positioned in close proximity to and upstream of sealing area 316 within seat 312. Lower filter 100, as shown in detail in FIGS. 1a through 1d, is positioned upstream of guide 330 and upstream of ball 314 to avoid interference with the guidance of ball 314 while particulates that may be generated internally within a fuel injector, such as fuel injector 200 as shown in FIG. 2, and that may be harmful to the injector operation are captured before reaching a valve guide area 332 between guide 330 and ball 314 and sealing area 316 between the seat 312 and the ball 314. Second internal valve assembly 310 may replace internal valve assembly 210 in fuel injector 200 as shown in FIGS. 2 and 3.

Lower filter 100 is attached to an annular retaining ring 350 that is assembled into seat 312. Lower Filter 100 is preferably attached to retaining ring 350 prior to assembly of retaining ring 350 in seat 312 forming a sub-assembly. Retaining ring 350 may be formed, for example, of a stainless steel. Retaining ring 350 is attached to area 126 of disk 110 of lower filter 100 such that an outer circumferential contour of disk 110 overlaps with an inner circumferential contour of retaining ring 350. For example, an outer diameter 352 of retaining ring 350 extends beyond outer diameter 114 of disk 110 and an inner diameter 354 of retaining ring 350 does not extend beyond area 126. Accordingly, retaining ring 350 does not cover filter hole area 116 of lower filter 100.

Retaining ring 350 is assembled in seat 312 preferably such that lower filter 100 is positioned upstream of ball 314 such that inner diameter 112 of disk 110 surrounds shaft 318 of valve assembly 310. Outer diameter 114 of disk 110 is adapted to loosely fit into an inner circumferential contour of seat 312. Inner diameter 112 of lower filter 100 is designed to closely fit around an outer diameter of shaft 318 without interfering with the reciprocating movement of shaft 318, precluding particles or internal contaminants from entering valve guide area 332 and sealing area 316. Seat 312 may include a shoulder 322 integrated into the inner circumferential contour that may assist in positioning retaining ring 350. Retaining ring 350 with lower filter 100 attached is inserted into seat 312 until it makes contact with shoulder 322. Shoulder 322 may have a smaller width than shoulder 222 shown in FIG. 3.

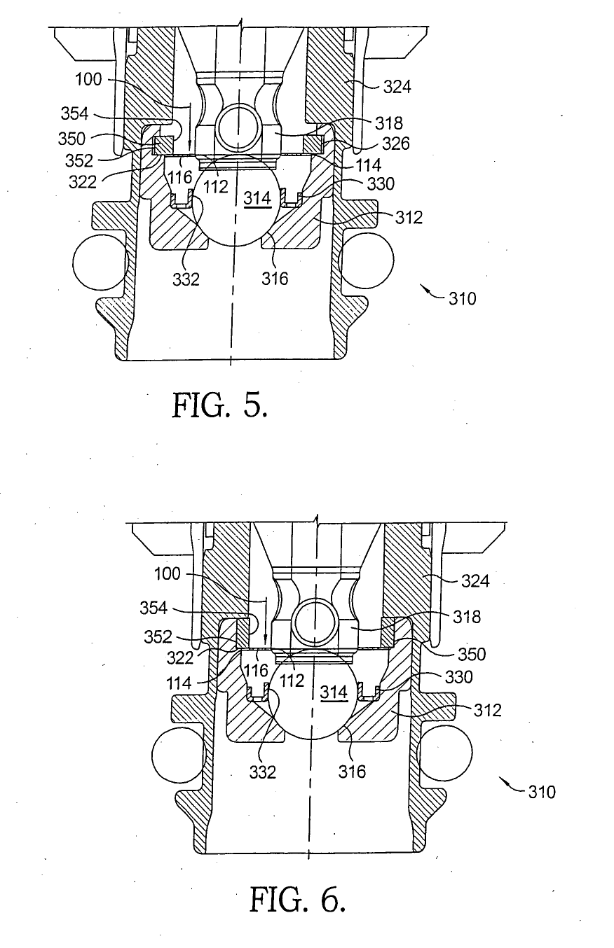

Retaining ring 350 may be retained within seat 312 by either a press fit into an inner circumferential contour of seat 312 as shown in FIG. 4 or by a snap fit into a groove 326 incorporated into the inner circumferential contour of seat 312 as shown in FIG. 5. It may be further possible to capture retaining ring 350 between a body 324 of a fuel injector and shoulder 322 of seat 312 during assembly of seat 312 and body 324 as shown in FIG. 6. This may be achieved in two ways, first (as shown in FIG. 6) by designing retaining ring 350 to have a larger thickness compared to the retaining ring 350 shown in FIGS. 4 and 5 or by designing seat 312 to have a smaller axial length above shoulder 322 than seat 312 shown in FIGS. 4 and 5.

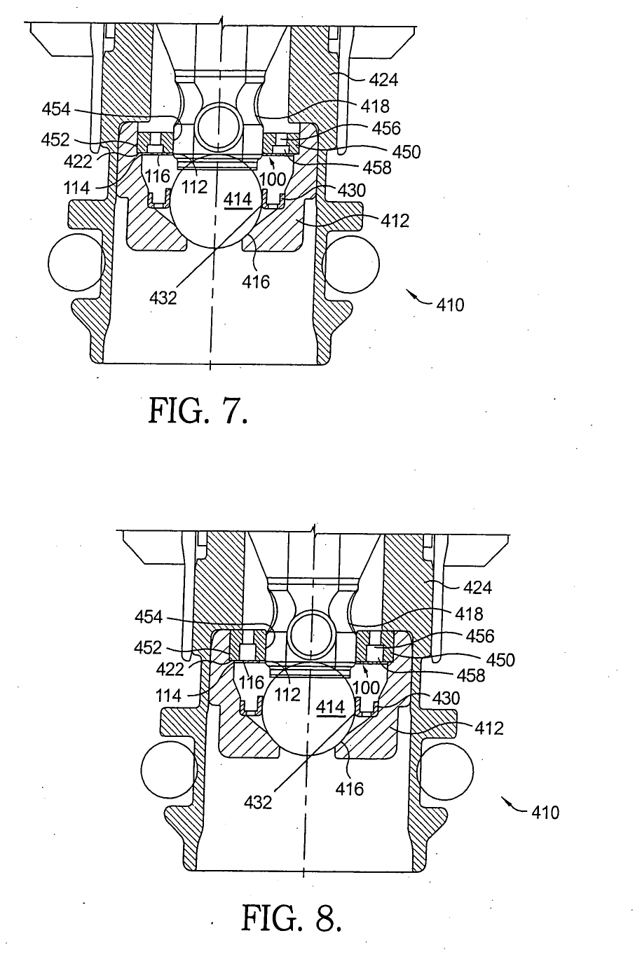

Referring to FIGS. 7 through 9, a third internal valve assembly includes a seat 412, a reciprocably actuated ball 414, that seals against seat 412, for example, in a circular sealing area 416, and a shaft 418 extending axially from ball 414. A guide 430 that directs ball 414 is positioned in close proximity to and upstream of sealing area 416 within seat 412. Lower filter 100, as shown in detail in FIGS. 1a through 1d, is positioned upstream of guide 430 and ball 414 to avoid interference with the guidance of ball 414 while particulates that may be generated internally within a fuel injector and that may be harmful to the injector operation are captured before reaching a valve guide area 432 between guide 430 and ball 414 and sealing area 416 between the seat 412 and the ball 414. Third internal valve assembly 410 may replace internal valve assembly 210 in fuel injector 200 as shown in FIGS. 2 and 3.

Lower filter 100 is attached to an annular support ring 450 that includes a plurality of flow through holes 456. Lower filter 100 is preferably attached to support ring 450 prior to assembly of support ring 450 in seat 412 thereby forming a sub-assembly. The support ring 450 and lower filter 100 sub-assembly is then installed into seat 412 eliminating the need to handle multiple parts during assembly.

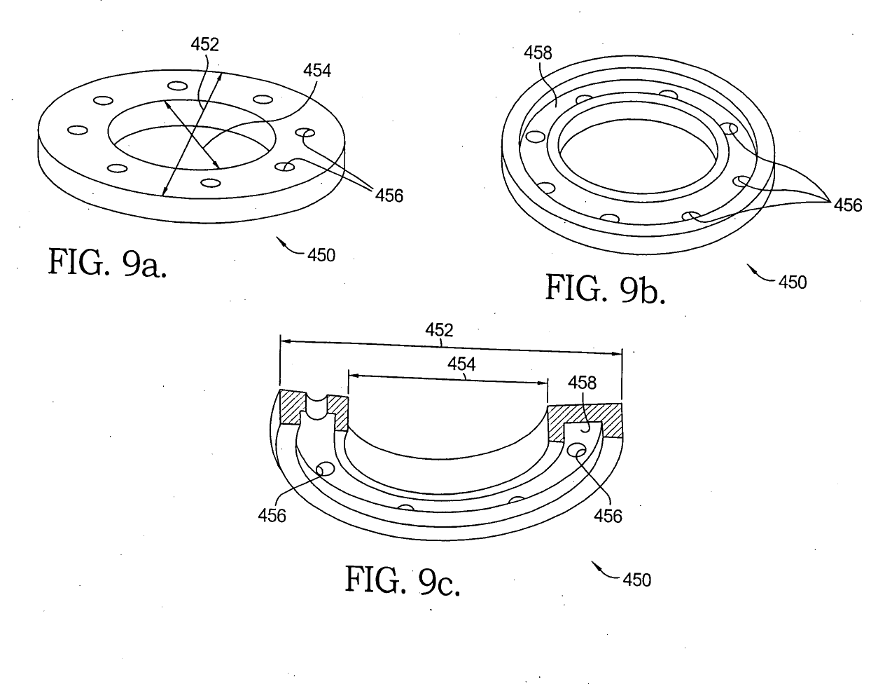

Annular support ring 450, shown in detail in FIGS. 9a through 9c, may be formed, for example, of a stainless steel. Support ring 450 includes an outer diameter 452, an inner diameter 454, and a circular channel 458 positioned there between. Inner diameter 454 of support ring 450 is adapted to closely fit around shaft 418 without limiting the reciprocating movement of shaft 418, thereby precluding particles or internal contaminants from entering valve guide area 432 and sealing area 416. Outer diameter 452 is adapted to closely fit into an inner circumferential contour of seat 412. Channel 458 is formed in one of the surfaces of support ring 450 and adapted to receive lower filter 100. Since support ring 450 stabilizes lower filter 100, it may be possible to form lower filter 100 to have a smaller overall thickness than thickness 122 as shown in FIG. 1c. When using support ring 450, disk 110 (FIGS. 1a-1d) may not need to be self-supporting. Flow through holes 456 may be formed above channel 458. When attached to support ring 450, filter hole area 116 of lower filter 100 is positioned below flow through holes 456. The number and size of flow through holes 456 may be selected according to the desired fuel flow through support ring 450. By assembling lower filter 100 in channel 458 of support ring 450, possible assembly damage to filter hole area 116 is reduced.

Seat 412 may include a shoulder 422 integrated into the inner circumferential contour that may assist in positioning support ring 450. Support ring 450 with lower filter 100 attached is inserted into seat 412 until it makes contact with shoulder 422. Shoulder 422 may have a smaller width than shoulder 222 shown in FIG. 3. While support ring 450 is shown in FIGS. 7 and 8 assembled with channel 458 facing guide 430, it may also be assembled with channel 458 facing away from guide 430.

Support ring 450 may be retained within seat 412 by either a press fit into an inner circumferential contour of seat 412 as shown in FIG. 7 or by a snap fit into a groove incorporated into the inner circumferential contour of seat 312 in a similar way as shown in FIG. 5 for retaining ring 350. It may be further possible to capture support ring 450 between a body 424 of a fuel injector and shoulder 422 of seat 412 during assembly of seat 412 and body 424 as shown in FIG. 8. This may be achieved in two ways, first (as shown in FIG. 8) by designing support ring 450 to have a larger thickness compared to the support ring 450 shown in FIG. 7 or by designing seat 412 to have a smaller axial length above shoulder 422 than seat 412 shown in FIG. 7.

By capturing particles or contaminants generated within a fuel injector, for example fuel injector 200, with lower filter 100 in accordance with a preferred embodiment of the invention, failure modes of the injector, such as a stuck open condition that may lead to a hydraulic lock of the engine, can be reduced compared to prior art fuel injectors that are operated without an internal lower filter. By installing lower filter 100 upstream of a ball guide, such as guide 230, 330, or 430, and without contact to the ball guide, internally generated contaminants are captured before reaching the ball and guide interface and the ball and seat interface while avoiding interference with the guidance and reciprocal movement of the ball, such as ball 214, 314, and 414.

While the lower filter 100 in accordance with the invention may be especially useful for applications in fuel injectors for multi-port fuel injection as described above, lower filter 100 may also be utilized in fuel injectors for direct injection.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A lower filter for a fuel injector, comprising:
a disk having an annular shape and including a plurality of filter holes;
wherein said disk is positioned upstream of a valve guide of an internal valve assembly without contacting said valve guide; and
wherein said disk prevents internally generated contaminants contained in fuel flowing through said filter holes from reaching a valve guide area and a sealing area of said internal valve assembly, wherein said valve guide area is positioned adjacent to said valve guide and wherein said sealing area is positioned downstream of said valve guide.

2. The lower filter of claim 1, wherein said disk is self-supporting.

3. The lower filter of claim 1, wherein said disk includes a first circular area adjacent to an outer diameter, a second circular area adjacent to an inner diameter, and a circular filter hole area positioned between said first circular area and said second circular area, and wherein said filter holes are positioned in said filter hole area and not in said first or second circular areas.

4. The lower filter of claim 3, wherein said first circular area and said second circular area have a first thickness, wherein said filter hole area has a second thickness that is smaller than said first thickness.

5. The lower filter of claim 1, wherein said filter holes are chemically etched holes.

6. The lower filter of claim 1, wherein each of said filter holes have a diameter that is smaller than a maximum distance between a valve and a seat of said valve assembly when said valve is in an open position.

7. The lower filter of claim 1, wherein said filter holes are arranged in a pattern.

8. The lower filter of claim 1, wherein said disk is retained within said fuel injector by spot-welds positioned adjacent to an outer diameter of said disk.

9. The lower filter of claim 1, wherein said disk includes dimples proximate to an outer diameter, and wherein said dimples enable resistant weld retention of said disk within said fuel injector.

10. The lower filter of claim 1, wherein said disk is retained within said fuel injector by a retention ring or by a support ring.

11. An internal valve assembly of a fuel injector, comprising:
a seat;
a reciprocably actuated valve that seals against said seat in a sealing area;
a guide positioned upstream of said sealing area and directing said valve in a valve guide area; and
a self-supporting lower filter positioned upstream of said guide without contacting said guide;
wherein said lower filter prevents contaminants contained in fuel flowing through said lower filter from reaching said valve guide area and said sealing area.

12. The internal valve assembly of claim 11, wherein said seat includes a shoulder, and wherein said lower filter is assembled into said seat to make contact with said shoulder.

13. The internal valve assembly of claim 12, wherein spot welds secure said lower filter to said shoulder.

14. The internal valve assembly of claim 11, wherein said lower filter includes an annular disk having an outer diameter and an inner diameter, wherein said outer diameter fits closely into an inner circumferential contour of said seat, and wherein said inner diameter fits closely around said valve.

15. The internal valve of claim 11, wherein said lower filter includes a circular filter hole area that includes a plurality of filter holes, and wherein each of said filter holes have a diameter that is smaller than a maximum distance between a valve and a seat of said valve assembly when said valve is in an open position.

16. The internal valve of claim 11, wherein said lower filter includes an annular disk attached to a retaining ring such that an outer circumferential contour of said disk overlaps with an inner circumferential contour of said retaining ring.

17. The internal valve assembly of claim 16, further including a shaft extending from said valve, wherein said annular disk is positioned upstream of said valve, and wherein at least one of said annular disk or retaining ring has an inner diameter that closely fits around an outer circumferential contour of said shaft without interfering with a reciprocating movement of said shaft.

18. The internal valve of claim 16, wherein said retaining ring is retained within said seat by a press fit.

19. The internal valve of claim 16, wherein an inner circumferential contour of said seat includes a groove, and wherein said retaining ring is retained within said seat by a snap fit into said groove.

20. The internal valve of claim 16, wherein said retaining ring is captured between a body of said fuel injector and a shoulder integral to said seat during assembly of said seat and said body.

21. The internal valve of claim 11, wherein said lower filter includes an annular disk and a support ring including a circular channel and flow through holes, wherein said channel receives said annular disk, wherein said flow holes are positioned above a circular flow hole area of said disk, wherein said support ring has an inner diameter adapted to closely fit around a shaft extending from said valve, and wherein said retaining disk has an outer diameter adapted to be retained within said seat.

22. A method for protecting an internal valve assembly of a fuel injector from internally generated contamination, comprising the steps of:
regulating a fuel flow through said fuel injector with a valve that is guided by a guide in a valve guide area and that seals against a seat in a sealing area;
assembling a lower filter upstream of said guide; and
capturing contaminants contained in said fuel flow with said lower filter before said contaminants reach said valve guide area and said sealing area.

23. The method of claim 22, further comprising the steps of:
integrating a shoulder into an inner circumferential contour of said seat;
inserting said lower filter into said seat until said lower filter makes contact with said shoulder; and
retaining said lower filter within said seat.

24. The method of claim 22, further comprising the steps of:
forming said lower filter as a self-supporting annular disk including a plurality of filter holes, and
retaining said disk within said seat with welds.

25. The method of claim 22, further comprising the step of:
forming said lower filter as an annular disk including a plurality of filter holes, and
retaining said disk within said seat with an annular retaining ring supporting only an outer circumference of said disk or with an annular support ring supporting the entire disk; and
assembling said disk and said retaining ring or said support ring to form a sub-assembly.
